(19) United States
(12) Patent Application Publication
(10) Pub. No.: US 2021/0370624 A1
(43) Pub. Date: Dec. 2, 2021

(54) METHOD FOR PRODUCING A THERMOPLASTICALLY DEFORMABLE, FIBER-REINFORCED FLAT SEMI-FINISHED PRODUCT

(71) Applicant: MITSUBISHI CHEMICAL ADVANCED MATERIALS COMPOSITES AG, Lenzburg (CH)

(72) Inventors: Tilo SCHIMANSKI, Kolliken (CH); Gautham Kumar BASKARAN, Lenzburg (CH)

(73) Assignee: MITSUBISHI CHEMICAL ADVANCED MATERIALS COMPOSITES AG, Lenzburg (CH)

(21) Appl. No.: 17/291,419

(22) PCT Filed: Nov. 5, 2019
(86) PCT No.: PCT/EP2019/080297

§ 371 Date: May 5, 2021

(30) Foreign Application Priority Data
Nov. 5, 2018 (EP) 18204437.0
Jan. 10, 2019 (EP) 19151243.3

(51) Int. Cl. B29C 70/50; B32B 19/04; B32B 19/06; B32B 3/26; B32B 5/02; B32B 5/26; B32B 5/28

(52) U.S. Cl. CPC B29C 70/506; B32B 2607/00; B32B 19/06; B32B 3/263; B32B 5/022; B32B 5/26; B32B 5/28; B32B 2250/02; B32B 2250/03; B32B 2250/20; B32B 2260/046; B32B 2260/023; B32B 2262/0261; B32B 2262/101; B32B 2262/106; B32B 2307/718; B32B 2307/732; B32B 19/04

(57) ABSTRACT

Thermoplastically moldable fiber reinforced planar semifinished products having a composite structure (A-B-A′) or (A-B) are produced by a method of applying to one or both sides of a flat, porous reinforcing-fiber thermoplastic material core layer precursor having an areal weight of 300 to 3,000 g/m², a fiber content of 20 to 60 wt.-% and an air void content of 20 to 80 vol.-%, at least one woven or nonwoven reinforcing fiber fabric having an areal weight of 100 to 1,000 g/m² and a thermoplastic layer having a low viscosity compared with the thermoplastic material of the core layer precursor and having an areal weight of 50 to 1,000 g/m², and heating and pressing the layer structure formed such that the low viscosity thermoplastic layer is melted and penetrates into the applied woven or nonwoven reinforcing fiber fabric and into the core layer and, after cooling, forms an integral bond with the core layer and cover layer.

### CROSS REFERENCE TO RELATED APPLICATIONS

This application is the U.S. National Phase of PCT Appln. No. PCT/EP2019/080297 filed Nov. 5, 2019, which claims priority to European Application No. EP 18204437.0 filed Nov. 5, 2018, and European Application No. EP 19151243.3 filed Jan. 10, 2019, the disclosures of which are incorporated in their entirety by reference herein.

### BACKGROUND OF THE INVENTION

### 1. Field of the Invention

The present invention relates to a method for producing a thermoplastically moldable fiber reinforced planar semifinished product. Moreover, the present invention relates to a method for subsequently producing a planar composite component.

### 2. Description of the Related Art

Composite components made of fiber-reinforced thermoplastics are increasingly used as molded parts in various fields of technology.

For example, WO 2015/117799 A1 describes a composite component comprising a foam core, on the surface of which a cover layer is arranged and integrally bonded to both sides of the foam core. For producing the composite component, the cover layers and the foam core are heated, then the cover layers are positioned on the surfaces of the foam core, and the whole is placed into a press or mold which is shaped in accordance with the finished composite component to be formed. The heating can also be carried out in the mold only. Subsequently, the foam core and the outer layers are molded and then cooled after a certain molding time, whereby an integral connection between foam core and cover layers is formed. As possible cover layers are mentioned, on the one hand, metallic cover layers, particularly made of aluminum. As an alternative, cover layers of fiber-reinforced plastic are also described. Because during the molding step the cover layers can be displaced on the surfaces of the foam core, the described method proves to be advantageous particularly for the production of non-planar composite components with a complex shape.

A related composite component and a method for its production are described in WO 2006/133586 A1. This relates to a flexurally rigid composite sheet, comprising:
A. one or two cover layers with a thickness of 0.5 to 5 mm made of glass fiber reinforced polypropylene with a glass content of 20 to 60 wt.-% and a content of air pores of less than 5 vol.-%, and
B. a core layer with a thickness of 2 to 40 mm made of glass fiber reinforced polypropylene with a glass content of 35 to 80 wt.-% and a content of air pores of 20 to 80 vol.-%.

In the described production method, the core layer to be used is provided as a porous plate, which, as described for example in WO 2006/105682 A1, can be prepared by dry blending of polypropylene fibers and glass fibers, needling of the blended nonwoven and hot pressing. As cover layers, conventional glass mat thermoplastic plates (commonly termed as “GMT plates”) are provided. The reinforcing fibers of the cover layers and of the core layer are already impregnated with thermoplastic prior to the production of the flexurally rigid composite sheet by means of a preceding heating and pressing process followed by interim storage as flexurally rigid plate elements. For producing the actual composite sheet, the layers to be pressed are then provided as plates, stacked on top of each other in a press and pressed at temperatures between 180 and 220° C. for 5 to 50 min. The described composite sheets are used, in particular, as partition walls and formwork panels in construction industry, but also as a substitute for chipboards in furniture manufacturing.

For production of a flexurally rigid composite component with the method described above, in which the cover and core layers are provided as already consolidated, rigid plates, a total of nine process steps are required, namely:
Provision of the core layer(s): 1) production of nonwoven, 2) impregnation of the reinforcing fibers in a hot press (under pressure & temperature), 3) consolidation in a cooling press;
Provision of the cover layers: 1) mat production, 2) extrusion, 3) impregnation in a hot press, 4) consolidation in a cooling press;
Production of the composite plate: 1) heating of the cover layers and core layer in a hot press, 2) cooling of the cover layers and core layer.

DE 195 20 477 A1 describes fiber-reinforced GMT plates which expand on heating due to the restoring forces of the glass mats and contain unevenly distribute air bubbles. For the production of such GMT panels, corresponding glass mats are first produced. Subsequently, the glass mats are impregnated with layers of extruded polypropylene melt or with polypropylene foils in a hot press, and then consolidated in a cooling press. The GMT plates so prepared are reheated after consolidation—when required—in order to induced an expansion as desired. The expanded GMT plates to be used as a support core can be pressed together with cover layers to form a sandwich molded part. The manufacturing method also described in DE 195 20 477 A1 is based on thermal pressing of a support core, which was cooled to room temperature and consequently solidified together with external layers provided as unexpanded GMT foils.

For producing a flexurally rigid composite component according to the method of DE 195 20 477 A1 it is necessary to carry out even twelve process steps, namely:
Provision of the core layer(s): 1) mat production, 2) extrusion of the melt layer on mats, 3) impregnation of the reinforcing fibers in a hot press (under pressure & temperature), 4) consolidation in a cooling press, 5) heating of the consolidated core layers, so that they expand, 6) cooling of the core layers;
Provision of the cover layer(s): 1) mat production, 2) extrusion, 3) impregnation in a hot press, 4) consolidation in a cooling press;
Production of the composite plate: 1) heating of the cover layers, 2) pressing of the cover layers with cold core layer; meaning that the production is limited to planar plates; for 3D parts, the cores would have to be molded accordingly in a preceding additional step, and then pressed with cover layers.

A further method for producing a fiber reinforced planar composite component is described in WO 2018/185090 A1, wherein one starts with non-consolidated layers made of reinforcing fibers and of thermoplastic fibers both for the core layer and for the cover layers. These layers are then consolidated only during pressing to form the composite component.

There is still a considerable need for further components, particularly for flexurally rigid, planar and, if required, three-dimensionally shaped composite components, but also for corresponding manufacturing methods which are simple and economical. In particular, methods are desired for producing composite components with properties that are significantly improved for particular applications.

### SUMMARY OF THE INVENTION

An object of the invention is therefore to provide a method for producing a thermoplastically moldable fiber reinforced planar semifinished product having a composite structure (A-B-A′) or (A-B). These objects are achieved by the production method defined herein, in which the (A) layers contain a thermoplastic with lower melt viscosity than the thermoplastic of the core layer (B).

### BRIEF DESCRIPTION OF THE DRAWINGS

Examples of the invention will henceforth be described in more detail by reference to the drawings, which show:

FIG. 1 the layer structure of a thermoplastically moldable fiber reinforced planar semifinished product according to the present invention, in a schematic sectional view;

FIG. 2 a system for carrying out the method according to the invention;

FIG. 3 a section of the semi-finished product in the form of a sandwich composite;

FIG. 4 a flat composite component, in a photographic view; and

FIG. 5 a section of the flat composite component of FIG. 4, in a photographic view.

### DETAILED DESCRIPTION OF THE PREFERRED EMBODIMENTS

Advantageous embodiments of the invention are described below and defined in the dependent claims.

According to a first aspect of the invention, there is disclosed a method for producing a thermoplastically moldable fiber reinforced planar semifinished product having a composite structure (A-B-A′) or (A-B). The said semifinished product comprises:
a core layer (B) made of a porous reinforcing-fibers thermoplastic material having an areal weight of 300 to 3,000 g/m², a fiber content of 20 to 60 wt.-% and an air voids content of 5 to 80 vol.-%, in particular of 10 to 50 vol.-%, and
one or two cover layers (A, A′) made of a woven or nonwoven reinforcing fiber fabric which are impregnated with a thermoplastic and which are integrally bonded to the core layer (B), wherein each cover layer has a thickness of 0.2 to 2.5 mm, an areal weight of 200 to 4,000 g/m² and an air voids content of less than 3 vol.-%.

The method according to the present invention comprises the following process steps:
a) applying to one or both sides of a core layer precursor in the form of a flat, porous reinforcing-fibers thermoplastic material having an areal weight of 300 to 3,000 g/m², a fiber content of 20 to 60 wt.-% and an air voids content of 20 to 80 vol.-%, at least one woven or nonwoven reinforcing fiber fabric having an areal weight of 100 to 1,000 g/m² and a thermoplastic layer having a low viscosity compared with the thermoplastic material of the core layer precursor and having an areal weight of 50 to 1,000 g/m²,
b) the layer structure (A-B) or (A-B-A′) thus formed is heated and pressed in such manner that the thermoplastic of the low viscosity thermoplastic layer is melted and penetrates into the applied woven or nonwoven reinforcing fiber fabric and into the core layer and, after cooling, forms an integral bond of the core layer and the cover layer;
   optionally followed by a further heating and pressing process.

With regard to step a), it should be noted that several, for example four, woven or nonwoven reinforcing fiber fabrics having an areal weight of 100 to 1,000 g/m² can be applied at one or both sides, thus increasing the areal weight of the resulting cover layer accordingly.

With regard to step b), it should be noted that during heating particularly the low viscosity thermoplastic layer, but also the thermoplastic material of the core layer precursor, is melted. The melted thermoplastic of the low viscosity thermoplastic layer is forced to penetrate into the core layer by means of the applied pressure. This process is favored by the fact that the thermoplastic of the low viscosity thermoplastic layer has a viscosity that is lower than that of the thermoplastic material of the core layer precursor.

According to a further aspect of the invention, a method for producing a planar composite component is disclosed. In this process, a thermoplastically moldable fiber reinforced planar semifinished product is produced by the method according to the present invention and is subsequently cut to a blank, and the blank thus formed is heated above the melting point of the thermoplastic and is formed into a planar composite component in a mold.

The term “thermoplastic” used here in the singular does not necessarily require that the thermoplastic material provided in the form of fibers, foils or ultimately as a matrix needs to be formed from a single thermoplastic material in all layers. In particular, mixed fibers of different, but compatible thermoplastics can also be used. “Compatible” shall be understood to refer to thermoplastics which allow formation of integral bonding.

The term “low viscosity thermoplastic layer” refers to a layer of a thermoplastic material whose viscosity is considerably lower than the viscosity of the thermoplastic material of the core layer precursor. By virtue of this fact the thermoplastic material of the low viscosity thermoplastic layer can easily be forced to penetrate through the woven reinforcing fabric of the cover layers into the core layer precursor, while at the same time the thermoplastic material of the core layer precursor undergoes comparatively little migration. The viscosity of thermoplastics is usually characterized by the melt flow index MFI. In the case of polypropylene, the melt flow index MFI (230° C., 2.16 kg) according to DIN 53735 lies in the range of 50 to 1,200 g/10 min, preferably of 100 to 400 g/10 min. For example, a polypropylene with a melt flow index of about 250 g/10 min can be used for the low viscosity thermoplastic layer and a polypropylene with a melt flow index of about 25 g/10 min can be used for the core layer.

It will be understood that in view of the intended pressing the term “heated” is to be understood in the sense that a temperature suitable for thermoplastic molding has been established. Therefore, any thermoplastics regions intended to be molded shall be heated to a temperature slightly above the respective thermoplastic melting temperature.

Depending on the thermoplastic material used, pressing to a composite component is carried out at corresponding temperatures, which when using polypropylene are in the range of about 180° C., and it is carried out at pressures of 1 to 100 bar.

Due to their layer arrangement, the planar composite components of the present invention are also referred to as “sandwich components”. Such components may be formed as flat or bent plates, but also as components with variable thickness and degree of deformation. They are characterized by a resistant, relatively hard and stiff outer layer and a voluminous, sound and heat insulating inner layer with a comparatively low density. Accordingly, the components are comparatively lightweight for a given stiffness.

The flat porous reinforcing-fibers thermoplastic material provided as a porous core layer precursor is basically known. According to an advantageous embodiment, the core layer precursor is provided in a textile nonwoven process. Such a process is described, for example, in WO 2006/105682 A1 and is based on dry blending of reinforcing fibers and thermoplastic fibers, needling of the blended nonwoven and hot pressing thereof.

Advantageously, the reinforcing fibers in the core layer precursor are nondirectional fibers needled to each other and having an average length (weight average) of 10 to 60 mm.

The low viscosity thermoplastic layer is preferably applied as a foil or as a powder, whereby in one embodiment the foil to be applied is supplied in liquid form, in particular by extrusion. In this way, the desired impregnation of the adjacent cover layer (A or A′) is achieved in the subsequent heating and pressing process.

According to one embodiment, heating and pressing are carried out continuously. Thereby, the initially formed layer structure (A-B) or (A-B-A′) is continuously fed (in-line) to a laminator. Therein, the thermoplastic is melted, and the reinforcing fibers in the core and cover layers are impregnated under pressure.

Alternatively, the heating and pressing can be carried out discontinuously, with flat blanks being placed into a pressing tool and processed one after the other.

Depending on the application field, the composite material thus produced can be heated again above the melting temperature of the thermoplastic in a second heating and consolidation process, which results in flipping upwards (lofting) of the core layer. The lofted composite material can then be pressed to reach a desired wall thickness. Alternatively, the second heating and consolidation step can also be used to laminate cover layers such as nonwovens, adhesive films or (decorative) foils onto the sandwich composite product.

In principle, for the method of the present invention a plurality of established thermoplastics is available, the selection of which is within the scope of specialist knowledge. According to an advantageous embodiment (claim 9), the thermoplastic is selected from polypropylene (PP), polyamide (PA) and polyethylene terephthalate (PET).

Also for the selection of the reinforcing fibers a plurality of established fiber materials is available. According to an advantageous embodiment, the reinforcing fibers are selected from carbon fibers, glass fibers, aramid fibers, basalt fibers, and temperature-stable synthetic fibers. The latter term also includes fibers made of a thermoplastic having a melting point above the operating temperatures used in the heating and pressing process of the present invention. It is in accordance with specialist knowledge that the term “temperature-stable fiber” in the present context is to be understood in comparison with the thermoplastic materials used. For a use together with the comparatively low-melting polypropylene, fibers with a melting point above 200° C. are to be understood as temperature-stable.

It will be understood that the selection of the thermoplastics as well as of the fiber materials, and accordingly also the combination of thermoplastic and fiber material, are strongly influenced by the field of application of the component to be produced.

Using the method for producing a planar composite component according to the present invention, it is possible, for example, to produce flexurally rigid sandwich components which are substantially planar. According to one embodiment of the method (claim 12), sandwich components with locally different thicknesses, i.e., 3-dimensionally structured planar composite components of various types, can be produced by means of appropriately formed pressing tools.

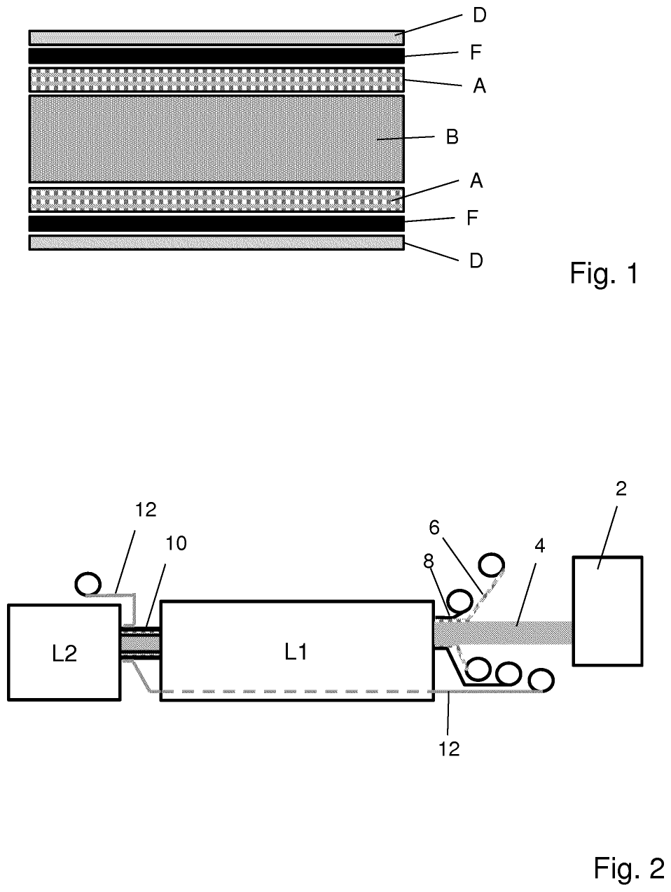

The thermoplastically moldable fiber reinforced planar semifinished product shown in FIG. 1 has a composite structure (A-B-A′). The latter comprises a core layer (B) made of a porous reinforcing-fibers thermoplastic material and two cover layers (A, A′) integrally bonded thereto, which are made of a woven reinforcing fiber fabric impregnated with a thermoplastic. In the example shown here, the two cover layers are identical, i.e. a symmetrical composite structure (A-B-A is present. Typically, each cover layer comprises several, typically two to four, preferably identical woven or nonwoven reinforcing fiber fabrics which are stacked on top of each other.

The two cover layers A lie directly on the core layer in the semifinished product, and they are each covered with a low viscosity thermoplastic layer in the form of a film (F). In the example shown, a decorative film (D) is applied to the outside of the thermoplastic film.

A system for continuously carrying out the method is shown in FIG. 2, with the processing direction principally running from right to left. A woven or nonwoven reinforcing fiber fabric 6 and a high viscosity thermoplastic film 8 from corresponding supply rolls are applied to both sides of a core layer precursor 4 exiting from a needling device 2. The layer structure thus formed is fed to a first laminator L1, where it is heated and pressed to form a composite product 10.

In the example shown, a further heating and pressing process is carried out in a second laminator L2. Therein, a cover layer 12 is applied, again on both sides.

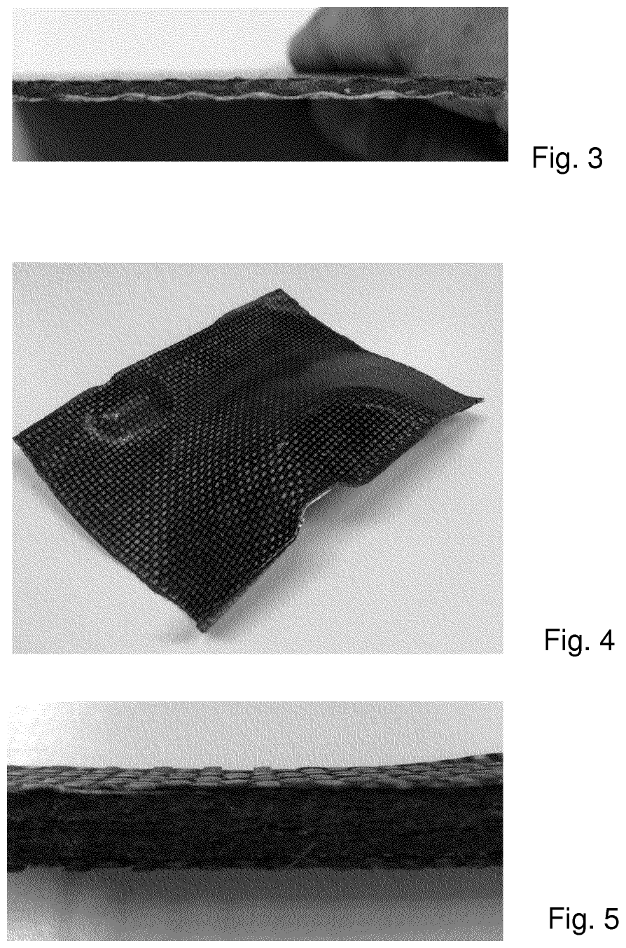

A composite component produced according to the invention is shown in FIGS. 3 to 5. The terms “a” and “an” are intended to refer to multiple items as well as a single item.

1.-12. (canceled)

13. A method for producing a thermoplastically moldable fiber reinforced planar semifinished product having a composite structure (A-B-A′) or (A-B), comprising:
a core layer (B) comprising a porous reinforcing-fiber-containing thermoplastic material having an areal weight of 300 to 3,000 g/m², a fiber content of 20 to 60 wt.-% and an air void content of 5 to 80 vol.-%, and
one or two cover layers (A, A′) comprising a woven or nonwoven reinforcing fiber fabric impregnated with a thermoplastic and which are integrally bonded to the core layer (B), wherein each cover layer has a thickness of 0.2 to 2.5 mm, an areal weight of 200 to 4,000 g/m² and an air void content of less than 3 vol.-%,
the method comprising:
a) applying to one or both sides of a core layer precursor in the form of a flat, porous rein-forcing-fibers thermoplastic material having an areal weight of 300 to 3,000 g/m², a fiber content of 20 to 60 wt.-% and an air void content of 20 to 80 vol.-%, at least one woven or nonwoven reinforcing fiber fabric having an areal weight of 100 to 1,000 g/m² and a thermoplastic layer having a low viscosity compared with the thermoplastic material of the core layer precursor and, having an areal weight of 50 to 1,000 g/m²,
b) heating and pressing the layer structure (A-B) or (A-B-A′) thus formed in such manner that the thermoplastic of the low viscosity thermoplastic layer is melted and penetrates into the applied woven or nonwoven reinforcing fiber fabric and into the core layer and, after cooling, forms an integral bond of the core layer with the cover layer;
optionally followed by one or more further heating and pressing processes.

14. The method of claim 13, wherein the core layer precursor is provided in a textile nonwoven form.

15. The method of claim 14, wherein the reinforcing fibers in the core layer precursor are nondirectional fibers needled to each other and having an average length (weight average) of 10 to 60 mm.

16. The method of claim 13, wherein the low viscosity thermo-plastic in the reinforcing fiber fabric is applied as a foil or as a powder.

17. The method of claim 13, wherein heating and pressing are carried out in a continuous process.

18. The method of claim 13, wherein heating and pressing are carried out discontinuously.

19. The method of claim 13, wherein, during a further heating and pressing process, the thermoplastic is initially melted with concomitant expansion of the core layer and then pressed to reach a predefined composite thickness.

20. The method of claim 13, wherein during a further heating and pressing process, at least one further cover layer is applied.

21. The method of claim 13, wherein the thermoplastic is selected from the group consisting of polypropylene, polyamide, and polyethylene terephthalate.

22. The method of claim 13, wherein the reinforcing fibers are selected from the group consisting of carbon fibers, glass fibers, aramid fibers, basalt fibers, temperature-stable synthetic fibers, and mixtures thereof.

23. A method for producing a planar composite component, wherein a thermoplastically moldable fiber reinforced planar semifinished product produced by the method of claim 13, cut into a blank, and the blank thus formed is heated above the melting point of the thermoplastic and is formed into a planar composite component in a mold.

24. The method of claim 23, wherein the planar composite component is formed with locally different thicknesses.
